(19) United States
(12) Patent Application Publication
(10) Pub. No.: US 2006/0029837 A1
(43) Pub. Date: Feb. 9, 2006

(54) Humidifier bypass system and method for PEM fuel cell

(76) Inventors: Mohammed E. Sennoun, Rochester, NY (US); Robert C. Reid, Livonia, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/912,298

(22) Filed: Aug. 5, 2004

(51) Int. Cl. H01M 8/00; H01M 2/02

(52) U.S. Cl. 429/12; 429/34; 429/13

(57) ABSTRACT

A humidifier bypass system for a fuel cell is disclosed. The humidifier bypass system includes a cathode and/or anode inlet conduits for carrying a cathode and/or anode inlet streams. A humidifier is provided in fluid communication with the cathode and/or anode inlet conduits for receiving and humidifying the cathode and/or anode inlet streams. A fuel cell is provided in fluid communication with the humidifier for receiving the cathode and/or anode inlet streams from the humidifier. A cathode and/or anode humidifier bypass conduits connects the cathode and/or anode inlet conduits to the fuel cell for selectively shunting the cathode and/or anode inlet streams around the humidifier to the fuel cell. A humidifier bypass method for a fuel cell is also disclosed.

### FIELD OF THE INVENTION

The present invention relates to polymer electrolyte membrane (PEM) fuel cells used to generate electricity in fuel cell electric vehicles. More particularly, the present invention relates to a system and method for periodically bypassing humidification of oxygen and/or hydrogen passing to a cathode/anode in a fuel cell in order to prevent excessive accumulation of water in the fuel cell and enhance fuel cell performance.

### BACKGROUND OF THE INVENTION

Fuel cell technology is a relatively recent development in the automotive industry. Fuel cells include three components: a cathode, an anode and an electrolyte which is sandwiched between the cathode and the anode and passes only protons. Each electrode is coated on one side by a catalyst. In operation, the catalyst on the anode splits hydrogen into electrons and protons. The electrons are distributed as electric current from the anode, through a drive motor and then to the cathode, whereas the protons migrate from the anode, through the electrolyte to the cathode. The catalyst on the cathode combines the protons with electrons returning from the drive motor and oxygen from the air to form water. Individual fuel cells can be stacked together in series to generate increasingly larger quantities of electricity.

In a Polymer-Electrolyte-Membrane (PEM) fuel cell, a polymer electrode membrane serves as the electrolyte between a cathode and an anode. The polymer electrode membrane currently being used in fuel cell applications requires a certain level of humidity to facilitate conductivity of the membrane. Therefore, maintaining the proper level of humidification in the membrane, through humidity/water management, is very important for the proper functioning of the fuel cell. Irreversible damage to the fuel cell will occur if the membrane dries out. For this reason, hydrogen and air are typically distributed through a humidifier prior to entry into the fuel cell.

During the conversion of hydrogen and oxygen (air) to electricity, water is produced as a reaction by-product. The by-product water is removed from the fuel cell by a cathode exhaust conduit.

Depending on the arrangement or design of the fuel cell system, the water in the cathode exhaust can be utilized in the fuel cell. This assists in the water management of fuel cells used in mobile applications. Depending on the conditioning of the cathode exhaust, small heat loss to the environment and condensation of the reaction product water in the fuel cell cannot be prevented. However, the inclusion of large quantities of liquid water must be avoided for proper operation of the fuel cell. At lower environmental temperatures, the heat loss and condensation will increase. Therefore, during winter operation of a vehicle, the formation of ice is a possibility and must be avoided.

In the fuel cell, a gas diffusion medium made from carbon fiber paper, carbon fiber fabric or cloth is attached to each of the electrodes to facilitate optimum diffusion of the reaction gases to the electrodes and provide optimum conduction of the electrical current from the fuel cell. In high current density (HCD) fuel cell stacks, fuel cell performance and stability can be significantly reduced by liquid water accumulation in gas channels and gas diffusion medium. In a phenomenon known as mass transfer resistance, liquid water accumulation plugs pores and channels in the gas diffusion medium, thereby hindering air or oxygen from reaching a catalyst layer on the cathode and reacting with protons to generate current. However, target performance levels of the fuel cell can only be achieved using costly gas diffusion media to overcome the effects of mass transfer resistance. This increases the costs associated with manufacture and maintenance of the fuel cell.

Therefore, an apparatus and method is needed to facilitate the attainment of target electrical performance levels in fuel cells which utilize a standard, relatively low-cost gas diffusion medium.

### SUMMARY OF THE INVENTION

The present invention is generally directed to a humidifier bypass system for periodically bypassing the usual flow of a cathode or anode inlet streams through a humidifier before the stream enters a fuel cell. For example, for the cathode streams, the humidifier bypass system includes a cathode inlet conduit and a cathode humidifier bypass conduit for selectively and periodically shunting a cathode inlet stream from the cathode inlet conduit and around a humidifier prior to entry of the cathode inlet stream into the cathode side of a PEM fuel cell. The humidifier bypass system may further include an anode inlet conduit and an anode humidifier bypass conduit for shunting an anode inlet stream from the cathode inlet conduit and around the humidifier prior to entry of the anode inlet stream into the inlet side of the fuel cell. By periodically shunting the cathode inlet stream or both the cathode and anode inlet streams around the humidifier and into the fuel cell, excessive accumulation or saturation of water in the gas diffusion medium in the fuel cell can be prevented or at least minimized. This facilitates diffusion of oxygen through the gas diffusion medium to the cathode. Consequently, electrical performance of a fuel cell that contains a gas diffusion medium characterized by standard diffusion paper is enhanced, thus eliminating the need for more costly diffusion paper in the fuel cell to attain optimum fuel cell performance.

The present invention is further directed to a humidifier bypass method for enhancing the electrical performance of a fuel cell. The method includes providing a cathode inlet stream, distributing the cathodeinlet stream through a humidifier and into a fuel cell, and periodically shunting the cathode inlet stream around the humidifier and into the fuel cell. The method may further include providing an anode inlet stream, distributing the anode inlet stream through the humidifier and into the fuel cell, and periodically shunting the anode inlet stream around the humidifier and into the fuel cell. The method prevents excessive humidification of a gas diffusion medium in the fuel cell, thus enhancing diffusion of oxygen through the gas diffusion medium to the cathode. This increases the reduction of oxygen and generation of current in the fuel cell, thereby enabling target fuel cell performance levels to be reached using standard diffusion paper as the gas diffusion medium in the fuel cell.

### BRIEF DESCRIPTION OF THE DRAWINGS

The invention will now be described, by way of example, with reference to the accompanying drawings, in which:

FIG. 1 is a schematic view of a humidifier bypass system according to the present invention;

### DETAILED DESCRIPTION OF THE INVENTION

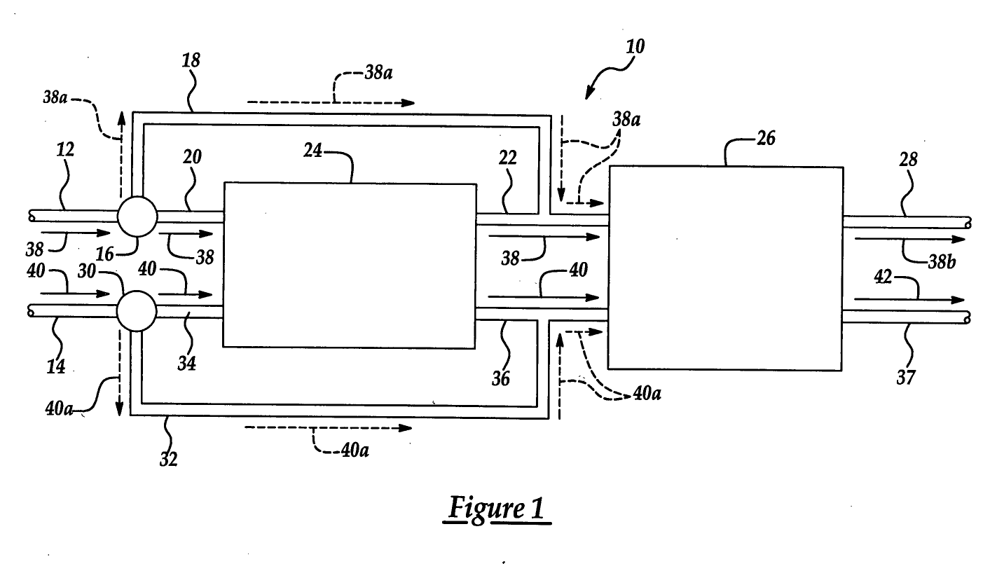

Referring initially to FIG. 1, an illustrative embodiment of the humidifier bypass system of the present invention is generally indicated by reference numeral 10. The humidifier bypass system 10 includes an anode inlet conduit 12 for conveying an anode inlet stream 38, which contains hydrogen fuel for operation of a PEM (Polymer-Electrolyte-Membrane) fuel cell 26; and a cathode inlet conduit 14 for conveying a cathode inlet stream 40, which contains oxygen that is reduced in the PEM fuel cell 26 to form water. The cathode inlet conduit 14 is provided in fluid communication with a three-way cathode humidifier bypass valve 30. A cathode humidifier inlet conduit 34 extends from the cathode humidifier bypass valve 30 and is provided in fluid communication with a humidifier 24. A cathode humidifier bypass conduit 32 extends from the cathode humidifier bypass valve 30 to a cathode fuel cell inlet conduit 36 which extends from the outlet end of the humidifier 24. The cathode fuel cell inlet conduit 36 is provided in fluid communication with the cathode side of the PEM fuel cell 26. A cathode outlet conduit 37 extends from the outlet on the cathode side of the PEM fuel cell 26 to distribute water vapor 42 as a reaction byproduct from the fuel cell 26.

The humidifier bypass system 10 typically further includes an anode humidifier bypass valve 16 which is provided in fluid communication with the anode inlet conduit 12. An anode humidifier inlet conduit 20 extends from the anode humidifier bypass valve 16 and is provided in fluid communication with the humidifier 24. An anode humidifier bypass conduit 18 extends from the anode humidifier bypass valve 16 to an anode fuel cell inlet conduit 22 which extends from the outlet end of the humidifier 24. The anode fuel cell inlet conduit 22 is provided in fluid communication with the anode side of the fuel cell 26. An anode outlet conduit 28 extends from the outlet on the anode side of the fuel cell 26 to distribute un-reacted hydrogen mixed with water vapor 38b from the fuel cell 26.

In operation of the humidifier bypass system 10, an anode inlet stream 38, which contains hydrogen fuel for the fuel cell 26, is distributed from a hydrogen fuel source (not shown) through the anode inlet conduit 12. A cathode inlet stream 40 is in like manner distributed through the cathode inlet conduit 14. Normally, the anode inlet stream 38 flows through the anode humidifier bypass valve 16 and anode humidifier inlet conduit 20, respectively, and into the humidifier 24. Simultaneously, the cathode inlet stream 40 flows through the cathode humidifier bypass valve 30 and cathode humidifier inlet conduit 34, respectively, and into the humidifier 24. In the humidifier 24, water vapor (not shown) is mixed with the anode inlet stream 38 and with the cathode inlet stream 40, respectively. The anode inlet stream 38 and cathode inlet stream 40 remain separate from each other.

The humidified anode inlet stream 38 flows from the humidifier 24 through the anode fuel cell inlet conduit 22, from which the anode inlet stream 38 enters the anode side of the fuel cell 26. Simultaneously, the humidified cathode inlet stream 40 flows from the humidifier 24 through the cathode fuel cell inlet conduit 36, from which the cathode inlet stream 40 enters the cathode side of the fuel cell 26. In the fuel cell 26, hydrogen gas from the anode inlet stream 38 is supplied to the anode (not shown) of the fuel cell 26. A catalyst (not shown) on the anode splits the hydrogen gas into electrons and protons. The electrons are distributed as electric current from the anode, through a drive motor (not shown) and then to a cathode (not shown) in the fuel cell 26. The protons migrate from the anode, through a polymer electrode membrane (not shown) to the cathode. The catalyst on the cathode combines the protons with electrons returning from the drive motor and with oxygen from the cathode inlet stream 40 to form water, which is released as water vapor 42 from the fuel cell 26 through the cathode outlet conduit 37.

During certain operating conditions of the fuel cell 26, a gas diffusion medium (not shown) provided on the cathode in the cathode side of the fuel cell 26 become saturated with water and accumulates more of it. This hinders optimum diffusion of oxygen from the cathode inlet stream 40, to the cathode, and thus, hinders the quantity of current which can be generated by the fuel cell 26. Therefore, it becomes necessary to periodically shunt the cathode inlet stream 40, or both the cathode inlet stream 40 and the anode inlet stream 38, around the humidifier 24 prior to introduction of the cathode inlet stream 40 and anode inlet stream 38 into the fuel cell 26. This allows the gas diffusion medium in the fuel cell 26 to temporarily dry to a level that will not hurt membrane humidification and consequently proton conduction, thus eliminating water saturation of the gas diffusion medium and reducing mass transfer resistance to the diffusion of oxygen from the cathode inlet stream 40 to the cathode in the fuel cell 26. Consequently, reduction of oxygen and generation of current in the fuel cell is substantially enhanced, thus enabling target fuel cell performance levels to be reached using relatively, inexpensive, standard diffusion paper as the gas diffusion medium in the fuel cell 26.

Referring again to FIG. 1, shunting of the cathode inlet stream 40 around the humidifier 24 is accomplished typically as follows. The cathode inlet stream 40 is caused to bypass the humidifier 24 by operation of the cathode humidifier bypass valve 30. Accordingly, the cathode humidifier bypass valve 30 blocks further flow of the cathode inlet stream 40 through the cathode humidifier inlet conduit 34 and into the humidifier 24. Instead, the cathode inlet stream 40 flows through the cathode humidifier bypass conduit 32 as a shunted cathode inlet stream 40a, which enters the cathode fuel cell inlet conduit 36 and then flows into the cathode side of the fuel cell 26. The shunted cathode inlet stream 40a bypasses the humidifier 24, thus preventing humidification of the shunted cathode inlet stream 40a prior to its entry into the fuel cell 26. As a result, the RH (relative humidity) of the shunted cathode inlet stream 40a entering the fuel cell 26 is typically about 0% during the bypass period.

As the cathode inlet stream 40 is shunted around the humidifier 24, the anode inlet stream 38 is typically also shunted around the humidifier 24 in similar fashion. Accordingly, the anode humidifier bypass valve 16 blocks further flow of the anode inlet stream 38 through the anode humidifier inlet conduit 20 and into the humidifier 24. Instead, the anode inlet stream 38 flows through the anode humidifier bypass conduit 18 as a shunted anode inlet stream 38a. The shunted anode inlet stream 38a enters the anode fuel cell inlet conduit 22 and then flows into the anode side of the fuel cell 26. Because the shunted anode inlet stream 38a bypasses the humidifier 24, humidification of the shunted anode inlet stream 38a prior to its entry into the fuel cell 26 is prevented. Consequently, the RH of the shunted anode inlet stream 38a entering the fuel cell 26 is typically about 0% during the bypass period. Therefore, during this time the fuel cell 26 is being operated at an RH of 0%.

As the dry shunted anode inlet stream 38a and shunted cathode inlet stream 40a enter the fuel cell 26, the humidity of the gas diffusion medium in the fuel cell 26 is substantially lowered. This allows evacuation of the water already present in the fuel cell through the cathode outlet conduit 37 as water vapor 42, without introducing additional water into the fuel cell 26 via the anode fuel cell inlet conduit 22 and cathode fuel cell inlet conduit 36. Consequently, oxygen is substantially unhindered by water as the oxygen diffuses from the shunted cathode inlet stream 40a, through the diffusion medium and to the cathode in the fuel cell 26. As a result, the fuel cell voltage steadily increases from the steady state voltage by more than 50 mV.

After a period of sustained distribution of the dry shunted anode inlet stream 38a and shunted cathode inlet stream 40a into the fuel cell 26, the diffusion medium in the fuel cell 26 begins to dry beyond optimum levels. This hinders optimum diffusion of oxygen through the gas diffusion medium to the cathode. Therefore, the fuel cell voltage reaches a maximum level and then begins to decrease. Accordingly, it then becomes necessary to again distribute the cathode inlet stream 40 through the humidifier 24 for a period of time. This is accomplished by actuation of the cathode humidifier bypass valve 30, wherein further flow of the shunted cathode inlet stream 40a through the cathode humidifier bypass conduit 32 is blocked. Instead, the cathode inlet stream 40 again flows through the cathode humidifier inlet conduit 34 and into the humidifier 24, where water vapor is mixed with the cathode inlet stream 40. The humidified cathode inlet stream 40 flows from the humidifier 24, through the cathode fuel cell inlet conduit 36 and into the cathode side of the fuel cell 26.

As the cathode inlet stream 40 is distributed through the humidifier 24 and cathode fuel cell inlet conduit 36 and into the fuel cell 26, respectively, the anode inlet stream 38 is typically simultaneously distributed through the humidifier 24 as well. This is accomplished by actuation of the anode humidifier bypass valve 16, wherein the anode inlet stream 38 again flows through the anode humidifier inlet conduit 20 and into the humidifier 24, respectively. The humidified anode inlet stream 38 flows from the humidifier 24 through the anode fuel cell inlet conduit 22 and into the anode side of the fuel cell 26.

As the humidified cathode inlet stream 40 and anode inlet stream 38 enter the fuel cell 26, humidification of the gas diffusion medium in the fuel cell 26 is gradually restored. Consequently, optimum diffusion of oxygen from the cathode inlet stream 40 to the cathode occurs until saturation of the diffusion medium again takes place. This causes the fuel cell voltage to again drop to the steady state voltage level. At that point, by actuation of the cathode humidifier bypass valve 30, the cathode inlet stream 40 is again shunted from the humidifier 24 and distributed to the fuel cell 26 through the cathode humidifier bypass conduit 32 as the shunted cathode inlet stream 40a, as heretofore described. Simultaneously, by operation of the anode humidifier bypass valve 16, the anode inlet stream 38 is typically again shunted from the humidifier 24 and distributed to the fuel cell 26 through the anode humidifier bypass conduit 18 as the shunted anode inlet stream 38a. Accordingly, the shunted cathode inlet stream 40a and shunted anode inlet stream 38a again enter the fuel cell 26 at an RH of 0%, thus drying the gas diffusion medium in the fuel cell 26 and facilitating optimum diffusion of oxygen from the shunted cathode inlet stream 40a to the cathode. This causes the fuel cell voltage to again rise from the steady state voltage level by at least 50 mV, as heretofore described. After the diffusion medium begins to dry out, the cathode inlet stream 40 and anode inlet stream 38 are again distributed through the humidifier 24 to humidify each, and the cycle is repeated.

Periodically decreasing the humidity level (HFR) of the gas diffusion medium, results in a sudden increase of the fuel cell voltage from the initial steady state voltage level. The maximum voltage level gradually decreases as the gas diffusion medium dries and as humidity is again restored to the medium. Subsequently decreasing the humidity level of the gas diffusion medium results in another spike in the fuel cell voltage.

If a threshold voltage level for the fuel cell 26 (FIG. 1) is used to switch on the cathode humidifier bypass valve 30, or both the valve 30 and the anode humidifier bypass valve 16, to facilitate shunting of the cathode inlet stream 40 or stream 40 and anode inlet stream 38 around the humidifier 24, a sustained higher voltage can be attained under operating high current density conditions This facilitates sustained cycles of humidifying and drying the gas diffusion medium without damaging the polymer electrolyte membrane in the fuel cell 26. The sustained voltage can be attained in each of multiple repeating cycles by shunting the cathode inlet stream 40 and anode inlet stream 38 around the humidifier 24 to reduce humidification of the gas diffusion medium, followed by distributing the cathode inlet stream 40 and anode inlet stream 38 through the humidifier 24 to re-hydrate the gas diffusion medium.

When using a high cost diffusion media, increases in the operating voltage of a fuel cell responsive to decreases in the humidity of a gas distribution medium in the fuel cell was only 10 mV. Therefore, a gain of only 10 mV can be attained using expensive gas diffusion medium. This is compared to 50 mV using the inexpensive diffusion media in conjunction with the humidifier bypass system 10 described herein above with respect to FIG. 1.

While the preferred embodiments of the invention have been described above, it will be recognized and understood that various modifications can be made in the invention and the appended claims are intended to cover all such modifications which may fall within the spirit and scope of the invention.

What is claimed is:

1. A humidifier bypass system for a fuel cell, comprising:
a cathode inlet conduit for carrying a cathode inlet stream;
a humidifier provided in fluid communication with said cathode inlet conduit for receiving and humidifying the cathode inlet stream;
a fuel cell provided in fluid communication with said humidifier for receiving the cathode inlet stream from said humidifier; and
a cathode humidifier bypass conduit connecting said cathode inlet conduit to said fuel cell for selectively shunting the cathode inlet stream around said humidifier to said fuel cell.

2. The humidifier bypass system of claim 1 further comprising an anode inlet conduit provided in fluid communication with said humidifier for carrying an anode inlet stream and an anode humidifier bypass conduit connecting said anode inlet conduit to said fuel cell for selectively shunting the anode inlet stream around said humidifier to said fuel cell.

3. The humidifier bypass system of claim 2 further comprising an anode fuel cell inlet conduit connecting said humidifier to said fuel cell and wherein said anode humidifier bypass conduit is provided in fluid communication with said anode fuel cell inlet conduit.

4. The humidifier bypass system of claim 2 further comprising an anode humidifier bypass valve provided between said anode inlet conduit and said anode humidifier bypass conduit for selectively shunting the anode inlet stream between said humidifier and said anode humidifier bypass conduit.

5. The humidifier bypass system of claim 1 further comprising a cathode fuel cell inlet conduit connecting said humidifier to said fuel cell and wherein said cathode humidifier bypass conduit is provided in fluid communication with said cathode fuel cell inlet conduit.

6. The humidifier bypass system of claim 5 further comprising an anode inlet conduit provided in fluid communication with said humidifier for carrying an anode inlet stream and an anode humidifier bypass conduit connecting said anode inlet conduit to said fuel cell for selectively shunting the anode inlet stream around said humidifier to said fuel cell.

7. The humidifier bypass system of claim 6 further comprising an anode fuel cell inlet conduit connecting said humidifier to said fuel cell and wherein said anode humidifier bypass conduit is provided in fluid communication with said anode fuel cell inlet conduit.

8. The humidifier bypass system of claim 1 further comprising a cathode humidifier bypass valve provided between said cathode inlet conduit and said cathode humidifier bypass conduit for selectively shunting the cathode inlet stream between said humidifier and said cathode humidifier bypass conduit.

9. A humidifier bypass system for a fuel cell, comprising:
a cathode inlet conduit for carrying a cathode inlet stream;
a cathode humidifier inlet conduit provided in fluid communication with said cathode inlet conduit for receiving the cathode inlet stream;
a humidifier provided in fluid communication with said cathode humidifier inlet conduit for receiving and humidifying the cathode inlet stream;
a fuel cell provided in fluid communication with said humidifier for receiving the cathode inlet stream from said humidifier; and
a cathode humidifier bypass conduit connecting said cathode inlet conduit to said fuel cell for selectively shunting the cathode inlet stream around said humidifier to said fuel cell.

10. The humidifier bypass system of claim 9 further comprising an anode inlet conduit for carrying an anode inlet stream, an anode humidifier inlet conduit provided between said anode inlet conduit and said humidifier for distributing the anode inlet stream from said anode inlet conduit to said humidifier, and an anode humidifier bypass conduit connecting said anode inlet conduit to said fuel cell for selectively shunting the anode inlet stream around said humidifier to said fuel cell.

11. The humidifier bypass system of claim 10 further comprising an anode fuel cell inlet conduit connecting said humidifier to said fuel cell and wherein said anode humidifier bypass conduit is provided in fluid communication with said anode fuel cell inlet conduit.

12. The humidifier bypass system of claim 10 further comprising an anode humidifier bypass valve provided in fluid communication with said anode inlet conduit, said anode humidifier bypass conduit and said anode humidifier inlet conduit for selectively shunting the anode inlet stream between said humidifier and said anode humidifier bypass conduit.

13. The humidifier bypass system of claim 9 further comprising a cathode fuel cell inlet conduit connecting said humidifier to said fuel cell and wherein said cathode humidifier bypass conduit is provided in fluid communication with said cathode fuel cell inlet conduit.

14. The humidifier bypass system of claim 13 further comprising an anode inlet conduit for carrying an anode inlet stream, an anode humidifier inlet conduit provided between said anode inlet conduit and said humidifier for distributing the anode inlet stream from said anode inlet conduit to said humidifier, and an anode humidifier bypass conduit connecting said anode inlet conduit to said fuel cell for selectively shunting the anode inlet stream around said humidifier to said fuel cell.

15. The humidifier bypass system of claim 14 further comprising an anode fuel cell inlet conduit connecting said humidifier to said fuel cell and wherein said anode humidifier bypass conduit is provided in fluid communication with said anode fuel cell inlet conduit.

16. The humidifier bypass system of claim 9 further comprising a cathode humidifier bypass valve provided in fluid communication with said cathode inlet conduit, said cathode humidifier bypass conduit and said cathode humidifier inlet conduit for selectively shunting the cathode inlet stream between said humidifier and said cathode humidifier bypass conduit.

17. A method of enhancing electrical performance of a fuel cell, comprising:
providing a cathode inlet stream;
providing a fuel cell;
distributing said cathode inlet stream into said fuel cell; and
alternately humidifying and drying said cathode inlet stream prior to said distributing said cathode inlet stream into said fuel cell.

18. The method of claim 17 wherein said alternately humidifying and drying said cathode inlet stream comprises alternately humidifying said cathode inlet stream and drying said cathode inlet stream to a relative humidity of about 0%.

19. The method of claim 18 further comprising providing an anode inlet stream, distributing said anode inlet stream into said fuel cell and alternately humidifying and drying said anode inlet stream prior to said distributing said anode inlet stream into said fuel cell.

20. The method of claim 19 wherein said alternately humidifying and drying said anode inlet stream comprises alternately humidifying said anode inlet stream and drying said anode inlet stream to a relative humidity of about 0%.
